(19) United States
(12) Patent Application Publication
(10) Pub. No.: US 2021/0357821 A1
(43) Pub. Date: Nov. 18, 2021

(54) Parking Reservation System

(71) Applicant: Hansel Graef, Davie, FL (US)

(72) Inventor: Hansel Graef, Davie, FL (US)

(21) Appl. No.: 16/876,926

(22) Filed: May 18, 2020

(51) Int. Cl. G06Q 10/02; G07C 9/10; G06Q 20/32; G08G 1/14

(52) U.S. Cl. CPC G06Q 10/02; G07C 9/10; G06Q 2240/00; G08G 1/149; G06Q 20/3267

(57) ABSTRACT

The disclosure includes a device and system for reserving a parking space via a barricade and system for a future date and time. The device consists of a base, a pole or barricade, a solar panel, and a motion sensor. The pole stands while the parking spot is empty and lays flat to the ground when the parking spot is reserved and occupied. Communication between single and multiple parking spot barricade systems and cell phone circuits allow the customer to reserve the desired parking spot for a selected date and period of time.

### BACKGROUND OF THE INVENTION

### Field of Invention

Vehicle parking is the act of stopping and disengaging a vehicle and leaving it unoccupied. Parking on one or both sides of a road is often permitted, though sometimes with restrictions. Some buildings have parking facilities for use of the buildings' users. Countries and local governments have rules for design and use of parking paces.

Parking lots are essential for any major and/or local business establishment that allows multiple motorists to park their vehicles in an orderly fashion. However, parking spots are typically taken on a first come first serve basis. When a parking area is filled up to maximum capacity, drivers end up circling around the lot until they find the next available parking spot. This often causes the driver to misspend their time while waiting for another unoccupied car stall.

### BRIEF DESCRIPTION OF DRAWINGS

FIG. 1 depicts a parking spot barricade system in accordance with an embodiment of the present disclosure.

FIG. 2 depicts a flow chart of a method for saving a parking spot via a parking spot barricade system in accordance with an embodiment of the present disclosure.

### DETAILED DESCRIPTION

The present invention is a device and app for reserving a parking spot for a future date and time. Throughout the disclosure, the term “app” refers to an application running on electronic circuits in cell phones, computers, tablets and any device, particularly wireless communication remote devices. The terms ‘fold,’ and ‘folding,’ refer to an action of laying the vertical barricade from a ninety degree erect position to a supine position parallel with a parking surface on which the parking barricade system is disposed.

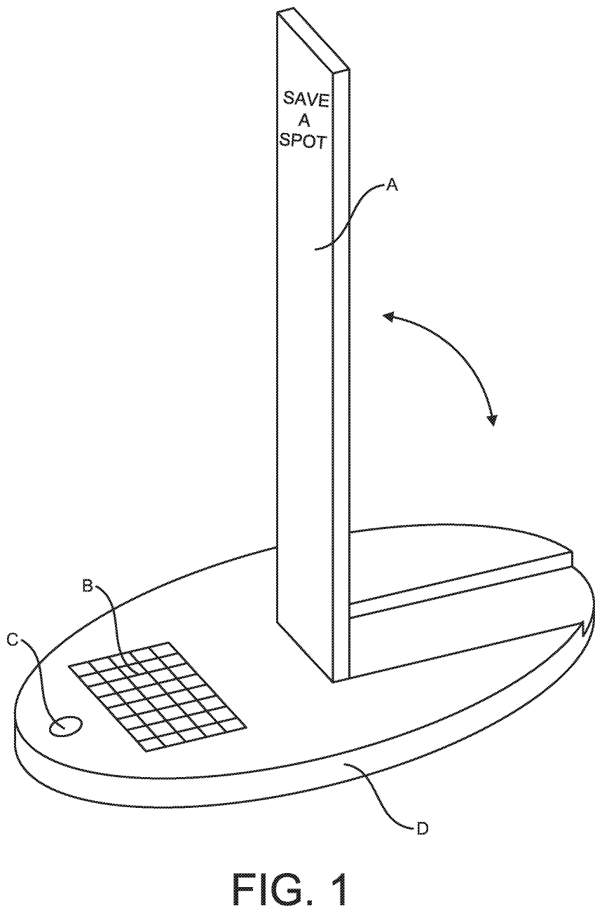

FIG. 1 depicts a parking spot barricade system in accordance with an embodiment of the present disclosure. The parking spot barricade system comprises a base, a sensor that communicates with the app, a solar panel, and a durable plastic pole or board. The barricade pole stands at a 90 degree angle when the parking space is empty. After the parking space is reserved and the customer comes to claim the parking spot, the barricade will fold down to lay flat on the ground. The sensor in the base of the barricade prevents the barricade from deploying when a vehicle is still parked in the space. It also allows the app to have real time information on which parking spaces are in use. The solar panel collects energy for carrying out actions needed for that space.

The “Save a Spot” app allows the customer to select a parking space from a map of the desired parking location. The customer then purchases use of the spot for the desired date and period of time.

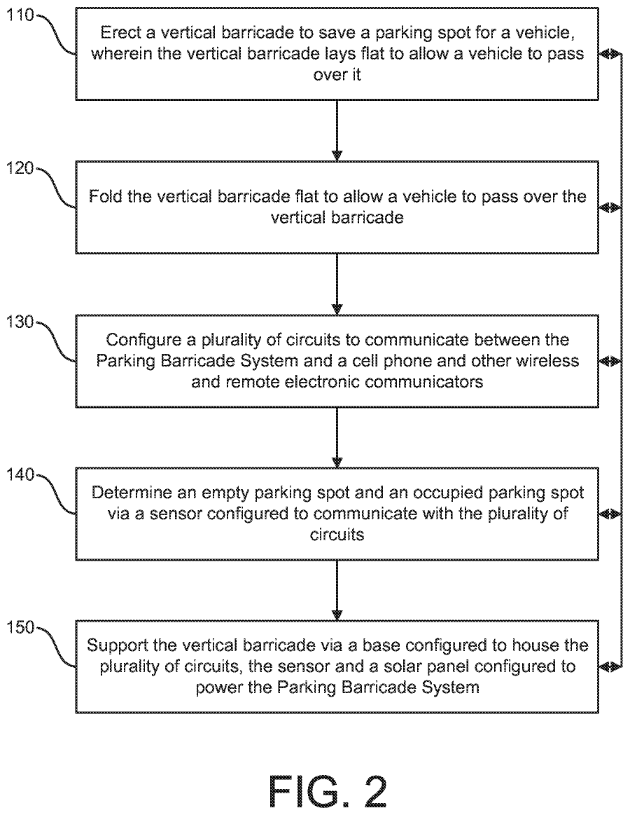

FIG. 2 depicts a flow chart of a method for saving a parking spot via a parking spot barricade system in accordance with an embodiment of the present disclosure. The method includes 110 erecting a vertical barricade to save a parking spot for a vehicle, wherein the vertical barricade lays flat to allow a vehicle to pass over it. The method also includes 120 folding the vertical barricade flat to allow a vehicle to pass over the vertical barricade. The method additionally includes 130 configuring a plurality of circuits to communicate between the PBS and a cell phone and other wireless and remote electronic communicators. The method further includes 140 determining an empty parking spot and an occupied parking spot via a sensor configured to communicate with the plurality of circuits. The method yet includes 150 supporting the vertical barricade via a base configured to house the plurality of circuits, the sensor and a solar panel configured to power the PBS. Embodiments of the method comprise folding the vertical barricade flat and swinging the vertical barricade erect via a powered hinge at an end of the flat bollard disposed at the base.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A parking barricade system (PBS) comprising:
a. a vertical barricade configured erect to save a parking spot for a vehicle and configured to fold flat to allow a vehicle to pass over the vertical barricade;
b. a plurality of circuits configured to communicate between the PBS and a cell phone and other wireless and remote electronic communicators;
c. a sensor configured to determine an empty parking spot and an occupied parking spot and communicate the determination to the plurality of circuits; and
d. a base configured to support the vertical barricade and house the plurality of circuits, the sensor and a solar panel configured to power the PBS.

2. The PBS of claim 1, wherein the vertical barricade is a flat bollard configured to lay flat and swing erect via a powered hinge at an end of the flat bollard disposed the base.

3. The PBS of claim 1, wherein the plurality of circuits comprises an electronic state machine designed to respond to the sensor determination, a status of the vertical barricade and the cell phone.

4. The PBS of claim 1, wherein the sensor is configured to determine an empty and an occupied parking spot via a reflection of an electromagnetic wave from a vehicle originating at the sensor and received at the sensor.

5. The PBS of claim 1, wherein the sensor is configured to determine an empty and an occupied parking spot via a reflection of an ultrasonic wave from a vehicle originating at the sensor and received at the sensor.

6. The PBS of claim 1, wherein the sensor is a proximity sensor able to detect a presence of a nearby object by looking for a change in an electromagnetic field emitted there from the proximity sensor.

7. The PBS of claim 1, wherein the base comprises a cutout to receive a thickness of the vertical barricade.

8. The PBS of claim 1, wherein the base comprises a thickness equal to a thickness of the vertical barricade.

9. The PBS of claim 1,wherein the base comprises an alternative electric source including a direct current battery and an alternating current socket and transformer.

10. A method for barricading vehicle parking via a parking barricade system (PBS), the method comprising:
a. erecting a vertical barricade to save a parking spot for a vehicle and configured to lay flat to allow a vehicle to pass over the vertical barricade;
b. folding the vertical barricade flat to allow a vehicle to pass over the vertical barricade;
c. configuring a plurality of circuits to communicate between the PBS and a cell phone and other wireless and remote electronic communicators;
d. determining an empty parking spot and an occupied parking spot via a sensor configured to communicate with the plurality of circuits; and
e. supporting the vertical barricade via a base configured to house the plurality of circuits, the sensor and a solar panel configured to power the PBS.

11. The method of claim 10, further comprising folding the vertical barricade flat and swinging the vertical barricade erect via a powered hinge at an end of the flat bollard disposed at the base.

12. The method of claim 10, further comprising sensing an empty and an occupied parking spot via reflecting an electromagnetic (EM) wave from a vehicle originating at the sensor and receiving the reflected EM wave at the sensor.

13. The method of claim 10, further comprising sensing an empty and an occupied parking spot via reflecting an ultrasonic wave from a vehicle originating at the sensor and receiving the ultrasonic wave at the sensor.

14. The method of claim 10, further comprising sensing a presence of a nearby object by looking for a change in an electromagnetic field emitted there from the sensor.

15. The method of claim 10, further comprising receiving a thickness of the vertical barricade into a cutout in the base having a same shape as the vertical barricade.

16. The method of claim 10, further comprising powering the PBS via an alternative electric source including a direct current battery and an alternating current socket and transformer.

17. A computer program product comprising a computer readable medium having computer useable code executable to perform operations for barricading vehicle parking via a parking barricade system (PBS), the operations of the computer program product comprising:
a. erecting a vertical barricade to save a parking spot for a vehicle and configured to lay flat to allow a vehicle to pass over the vertical barricade;
b. folding the vertical barricade flat to allow a vehicle to pass over the vertical barricade;
c. configuring a plurality of circuits to communicate between the PBS and a cell phone and other wireless and remote electronic communicators;
d. determining an empty parking spot and an occupied parking spot via a sensor configured to communicate with the plurality of circuits; and
e. supporting the vertical barricade via a base configured to house the plurality of circuits, the sensor and a solar panel configured to power the PBS.

18. The computer program product of claim 17, further comprising managing a plurality of PBS via communicating wirelessly between the plurality of circuits of each PBS and a cell phone circuitry.

19. The computer program product of claim 17, further comprising a map of available parking spots created from a plurality of PBS communicating with a cell phone circuitry.

20. The computer program product of claim 17, further comprising reserving an available parking spot via a plurality of PBS communicating with a cell phone circuitry.
